(19) United States
(12) Patent Application Publication
(10) Pub. No.: US 2024/0254058 A1
(43) Pub. Date: Aug. 1, 2024

(54) Compositions and Processes for Ultra-High Performance Microfiber Concrete

(71) Applicant: INTEGRATED COMPOSITE CONSTRUCTION SYSTEMS, LLC, MANASSAS, VA (US)

(72) Inventor: RICHARD A. BURGESS, III, MANASSAS, VA (US)

(21) Appl. No.: 18/564,022

(22) PCT Filed: May 28, 2022
(86) PCT No.: PCT/US22/31480

§ 371 Date: Nov. 24, 2023

Related U.S. Application Data
(63) Continuation-in-part of application No. 17/334,609, filed on May 28, 2021.
(60) Provisional application No. 63/343,103, filed on May 18, 2022.

(51) Int. Cl. C04B 40/00; C04B 14/02; C04B 14/06; C04B 14/32; C04B 14/48; C04B 18/08; C04B 18/14; C04B 28/04; C04B 40/02; C04B 103/30; C04B 103/32; C04B 111/94

(52) U.S. Cl. CPC C04B 40/0046; C04B 14/026; C04B 14/06; C04B 14/324; C04B 14/48; C04B 18/082; C04B 18/146; C04B 28/04; C04B 40/0042; C04B 40/0209; C04B 40/0263; C04B 40/0281; C04B 2103/302; C04B 2103/32; C04B 2111/94; C04B 2201/52

(57) ABSTRACT

The invention relates to processes for making improved ultra-high performance microfiber concrete and articles made from the same. The invention includes blending first dry constituents of fine aggregate, steel fiber, and cement to yield a first homogenous dry mix, optionally adding carbon nanotubes and/or silicon carbide microinclusions, followed by blending with second dry constituents of silica fume, silica flour, and cenospheres to obtain a second homogenous dry mix, followed by adding water only, with further blending, and finally adding a superplasticizer admix and a water-reducing admix to obtain ultra high performance microfiber concrete. The invention also relates to voltage heating for curing and for creating heated UHPC articles.

### BACKGROUND OF THE INVENTION

### Field of the Invention

The invention relates to compositions and processes for making improved ultra-high performance microfiber concrete with microinclusions with carbon nanotubes including voltage heating, and articles made from the same.

### DESCRIPTION OF THE RELATED ART

Durable construction materials come in many forms. However, there is still a need for improved compositions having properties desirable in construction projects.

### SUMMARY OF THE INVENTION

Accordingly, the invention provides compositions and processes for making such compositions that are useful in manufacturing ultra high performance concrete by mixing microinclusions into a dry mixture of first constituents to yield a dry homogeneous mix, the microinclusions selected from one or more of the group consisting of steel microfibers, carbon nanotubes, ultra-high molecular weight polyethylene fibers, multi-walled carbon nanotubes, and silicon carbide, the first constituents, comprising: cement of Blaine fineness of about 280 to about 360 m2/kg; sand, silica fume, silica flour, and optionally hydrated ceramic microspheres.

In preferred embodiments, the microinclusions are plasma-treated before mixing into the dry mixture of first constituents.

In other preferred embodiments, the silicon carbide and the multiwalled carbon nanotubes are obtained by heating agricultural waste husks in an inert atmosphere to a temperature higher than 1300 degrees C. to obtain a mixture containing silicon carbide and MWCNTs, which may optionally be separated before plasma treatment and use as microinclusions.

In other preferred embodiment, plasma-treated steel microfibers are added to the dry mixture of first constituents.

In another preferred embodiment, the invention provides ultra high performance cement paste and processes for making such ultra high performance cement paste by first adding water to the first homogeneous mix, and then adding at least one high-range water-reducing admixture; wherein said water and said high-range water-reducing admixture are blended with said first homogeneous mix to form a uniform cement-containing paste.

In other preferred embodiments, the plasma treatment comprises: (i) plasma cleaning to remove organic contamination, remove surface oxides, increase surface hydrophilic property, and improve adhesion, wherein the plasma treatment is selected from the group consisting of: Argon plasma micro-sandblasting, Hydrogen plasma treatment for removal of surface oxides on the recycled steel fibers, Helium plasma treatment, Nitrogen plasma treatment, and Oxygen plasma treatment; or (ii) plasma surface-modifcation by plasma enhanced chemical vapor deposition to coat the microinclusions with one or more layers selected from the group consisting of: carbon, silicon, carbon nanotubes, silicon carbide, silicon nitride, and mixtures thereof; and/or (iii) plasma surface energy modification to create one or more ultra-thin layers of a film that adjusts wetting properties to improve of the wettability and increase the mixability of the microinclusions in the composition.

The cement-containing paste is used to manufacture components are selected from the group consisting of: plates, channels, pipes, tubes, I-sections, WF-sections, connectors, panels, and combinations thereof.

Components made using the compositions herein are also employed to fabricate items selected from the group consisting of: vehicle up-armoring, ballistic armor, blast-resistant panels, man-portable panels, thin armor panels, forced entry resistant structural elements, roofing tiles, wall panels, floor tiles, hurricane and tornado resistant structural elements, and combinations thereof.

The compositions may also be cured to achieve enhanced strength by (i) placing in an environment of approximately 100% relative humidity for about seven days at ambient temperature, (ii) submersing in water of approximately 85° C. to about 91° C. for about three to about five days, and (iii) heating in air at approximately 85° C. to about 91° C. for about one to about two days, wherein, said cured composition component becomes crystalline unlike said composition components cured under ambient conditions as an amorphous calcium silicate hydrate.

In another preferred embodiment of the invention, there is provided a ultra high performance component, comprising: a form made using the composition(s) described herein, wherein the component has a strength of at least 10,000 psi, or has a strength of over 21,500 psi, or is heat cured and has a strength of over 50,000 psi, or is voltage cured and has a strength over 50,000 psi.

### BRIEF DESCRIPTION OF THE FIGURES

FIG. 1 shows a process flowchart illustrating one preferred process of this present invention. FIG. 1 shows the process of blending first dry constituents of fine aggregate, steel fiber, and cement to yield a first homogenous dry mix, followed by blending with second dry constituents of silica fume, silica flour, and cenospheres to obtain a second homogenous dry mix, followed by adding water only, with further blending, and finally adding a superplasticizer admix and a water-reducing admix to obtain ultra high performance microfiber concrete.

FIG. 2 is a process flowchart of another preferred process, using recycled plastic and recycled glass. FIG. 2 shows milling the agricultural waste to a powder, with any added silica and/or organic components. Heating the starting materials. And purifying the SiC and the MWCNTs.

FIG. 3 is a process flowchart illustrating the use of microinclusions (SiC and MWCNTs) in Ultra High Performance Concrete. FIG. 3 shows blending a cement mixture with fibers containing SiC and/or MWCNTs to obtain reinforced ultra-high performance concrete (UHPC). Surprisingly, it has been found that it is important for the microinclusions to be dry-blended with the first constituents to ensure the proper dispersion of the microinclusions within the resultant composition and to obtain homogeneity of the mixed components.

FIG. 4 is a process flowchart illustrating the process of converting agricultural waste to carbon nanotubes and silicon carbide.

FIG. 5 is a process flowchart illustrating the process of converting agricultural waste with glass and plastics to carbon nanotubes and silicon carbide.

FIG. 6 is a process flowchart illustrating the process of forming an UHPMC article.

FIG. 7 is a process flowchart illustrating the process of forming a heat-producing UHPMC article by applying a voltage supply to generate voltage heating in the embedded CNTs/steel fibers.

FIG. 8 is a table showing CorTuf CT25 UHPC properties.

FIG. 9 is a table showing psi strength after 3-day and 7-day curing periods for a mix designs compared to no fiber mixes, “UH-FIBER”, “DD FIBER”, and “3D mix”.

FIG. 10 is a table showing psi strength after 5-day and 7-day curing periods for a mix design “Day 1”.

FIG. 11 is an image of an H pile constructed using the CT-25 UHPC herein.

FIG. 12 is a table of CT25 UHPC constituents, packaging, and yield.

FIG. 13 is an image of a precast form (wall) made from a unitary pour of CT-25 UHPC.

FIG. 14 is a table of CT-25 UHPC testing results.

FIG. 15 is an image of a batch plant. FIG. 15 shows a mobile trailer having hopper bins connected by feeders/augers for sand, cement, UHPC additive, and microfibers, as well as containers for dispensing admix and water.

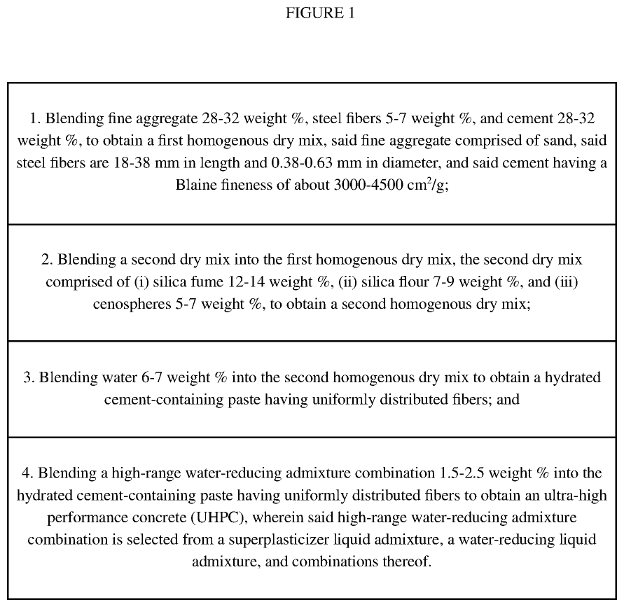

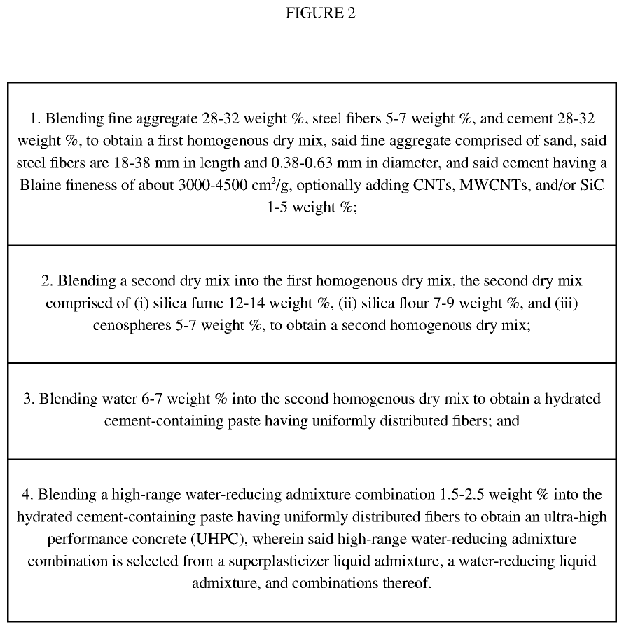

### DETAILED DESCRIPTION

Disclosed herein are embodiments directed to compositions and processes for making such compositions that are useful in manufacturing ultra high performance microfiber concrete by blending first dry constituents of fine aggregate, steel fiber, and cement to yield a first homogenous dry mix, followed by blending with second dry constituents of silica fume, silica flour, and cenospheres to obtain a second homogenous dry mix, followed by adding water only, with further blending, and finally adding a superplasticizer admix and a water-reducing admix to obtain ultra high performance microfiber concrete.

In one of the preferred embodiments of the invention, the process comprises 1. Blending fine aggregate 28-32 weight %, steel fibers 5-7 weight %, and cement 28-32 weight %, to obtain a first homogenous dry mix, said fine aggregate comprised of sand, said steel fibers are 18-38 mm in length and 0.38-0.63 mm in diameter, and said cement having a Blaine fineness of about 3000-4500 cm²/g;

2. Blending a second dry mix into the first homogenous dry mix, the second dry mix comprised of (i) silica fume 12-14 weight %, (ii) silica flour 7-9 weight %, and, optionally (iii) hydrated cenospheres 5-7 weight %, to obtain a second homogenous dry mix;

3. Blending water 6-7 weight % into the second homogenous dry mix to obtain a hydrated cement-containing paste having uniformly distributed fibers; and

4. Blending a high-range water-reducing admixture combination 1.5-2.5 weight % into the hydrated cement-containing paste having uniformly distributed fibers to obtain an ultra-high performance concrete (UHPC), wherein said high-range water-reducing admixture combination is selected from a superplasticizer liquid admixture, a water-reducing liquid admixture, and combinations thereof.

Also disclosed herein are embodiments directed to ultra high performance cement (UHPC) paste and processes for making UHPC paste comprising:
(i) mixing microinclusions into a dry mixture of first constituents, the microinclusions selected from one or more of the group consisting of carbon nanotubes, multi-walled carbon nanotubes, silicon carbide, and ultra-high molecular weight polyethylene fibers.

In another preferred embodiments, the microinclusions are plasma-treated before mixing.

In another preferred embodiment, the carbon nanotubes, silicon carbide and multiwalled carbon nanotubes are obtained by heating agricultural waste husks in an inert atmosphere to a temperature higher than 1300 degrees C. to obtain a mixture containing CNTs, silicon carbide and MWCNTs.

In another embodiment, the mixture containing CNTs, silicon carbide and MWCNTs is treated to extract CNTs and MWCNTs and separate the CNTs and MWCNTs from the silicon carbide, and wherein the plasma treatment of the CNTs and MWCNTs is separate from the plasma treatment of the silicon carbide.

In another preferred embodiment, plasma-treated steel microfibers are added to the dry mixture of first constituents.

Any of the embodiments herein may include wherein the plasma treatment of the microinclusions comprises plasma cleaning, plasma surface-modification, or plasma surface-energy modification.

Plasma cleaning comprises removal of organic contamination and surface oxides, increase of surface hydrophilic property, and improvement of adhesion, wherein the plasma treatment is selected from the group consisting of: Argon plasma micro-sandblasting, Hydrogen plasma treatment for removal of surface oxides on the recycled steel fibers, Helium plasma treatment, Nitrogen plasma treatment, and Oxygen plasma treatment.

Plasma surface-modification uses plasma enhanced chemical vapor deposition to coat the microinclusions with one or more layers selected from the group consisting of: carbon, silicon, carbon nanotubes, silicon carbide, silicon nitride, and mixtures thereof

Plasma surface energy modification creates one or more ultra-thin layers of a film that adjusts wetting properties to improve the wettability and increase the mixability of the microinclusions in the composition.

Any of the embodiments herein may include additional microinclusions are selected from the group consisting of: metals, alloys, steel, synthetics, polymers, natural inorganics, minerals, glass, asbestos, carbon, cellulose, synthetic organics, natural organics, sisal, and combinations thereof.

Any of the embodiments herein may include a composition as described and claimed wherein said cement is portland cement with a calcium to silica ratio of less than about 3.1.

Any of the embodiments herein may include a composition as described and claimed wherein said silica fume is at least 96% silica with a maximum carbon content of less than about 4%.

Any of the embodiments herein may include a composition as described and claimed wherein said silica flour is crushed silica of less than about 40 microns in its longest dimension.

Any of the embodiments herein may include wherein said microinclusions include fibers having lengths between about 18 to about 38 mm and in diameters between about 0.38 to about 0.63 mm.

Any of the embodiments herein may include wherein fibers incorporate ends selected from the group consisting of: hooked ends, approximately straight ends, bulbed ends, and combinations thereof.

Any of the embodiments herein may include fibers having a surface selected from the group consisting of: silica fume bonded to said surface, glass frit bonded to said surface, a roughened surface, and combinations thereof.

Any of the embodiments herein may include a composition as described and claimed further comprising mats of steel strands of diameter less than about 2.5 mm affixed to a tensile-load carrying face of said structure.

Any of the embodiments herein may include wherein said high-range water-reducing admixture comprises polycarboxylates, wherein said amount is in the range of about three to about 20 fluid ounces per 100 lb of said resultant cement-containing paste.

Any of the embodiments herein may include wherein said microinclusions are selected from the group consisting of: fiber microinclusions, spherical microinclusions, polyhedron microinclusions, and combinations thereof.

Any of the embodiments herein may include wherein said microinclusions have a longest dimension from about one micron to about 150 microns.

Any of the embodiments herein may include wherein microinclusions are fabricated from the group consisting of: metals, ceramics, organics, natural inorganics, natural minerals, synthetics, and combinations thereof.

Any of the embodiments herein may include configurations of said microinclusion materials are selected from the group consisting of: steel shavings, ceramic whiskers, ceramic spheres, mineral fibers, wollastonite, carbon fibers and combinations thereof.

Any of the embodiments herein may include wherein said cement-containing paste is a stiff dough with approximately zero slump.

Any of the embodiments herein may include wherein said cement-containing paste is a flowable mixture.

Any of the embodiments herein may include wherein said cement-containing paste is used to manufacture components are selected from the group consisting of: plates, channels, pipes, tubes, I-beam sections, H-beam components, WF-sections, smooth columns, fluted columns, connectors, panels, endcaps, overlays, wall panels, roofing tiles, floor tiles, underflooring, wall tiles, stepping stones, planters, trusses, joists, rafters, support gussets, decking, footers, mounting pads, precast water conduit, precast sewage pipes, precast pipe connectors, bricks, refractory bricks, fireplace liners, veneers, oil and gas well cementing for casings, seawalls, sea barrier blocks and forms, undersea pilings, undersea mounting pads, harbor docks, precast highway slabs, precast railroad ties, precast parking blocks, precast jersey barriers, street curbs, sidewalks, driveway aprons, countertops, laboratory bench tops, warehouse flooring slabs, power station towers, power station dams, and combinations thereof.

Any of the embodiments herein may include wherein said components are employed to fabricate items selected from the group consisting of: vehicle up-armoring, ballistic armor, blast-resistant panels, man-portable panels, thin armor panels, forced entry resistant structural elements, armored roofing tiles, ballistic wall panels, ballistic floor tiles, hurricane and tornado resistant structural elements, and combinations thereof.

In another preferred embodiment, the invention provides a method of producing a component of a structure, comprising: (i) Preparing a uniform cement-containing paste according to the processes herein; and (ii) Forming said resultant cement-containing paste in the shape of said component, and heating and hydrating said formed resultant cement-containing paste.

In another preferred embodiment, the invention provides a method as described and claimed wherein said forming is done by techniques selected from the group consisting of: spin casting, extrusion molding, pressure molding, pouring into forms, and combinations thereof.

In another preferred embodiment, the invention provides a method as described and claimed wherein said composition component is cured by: (i) placing in an environment of approximately 100% relative humidity for about seven days at ambient temperature, (ii) submersing in water of approximately 85° C. to about 91° C. for about three to about five days, and (iii) heating in air at approximately 85° C. to about 91° C. for about one to about two days, wherein, said cured composition component becomes crystalline. This crystalline structure is unlike components cured under ambient conditions which create weaker amorphous calcium silicate hydrate components having lower strength of 3500 psi or lower.

In another preferred embodiment of the invention, there is provided a ultra high performance component, comprising: a form made using the composition(s) described herein, wherein the component has a strength of at least 10,000 psi.

In another preferred embodiment, the component has a strength of over 21,500 psi.

In another preferred embodiment, the component is heat cured and has a strength from 50,000-100,000 psi.

### Process—Silicon Carbide, MW-CNTS

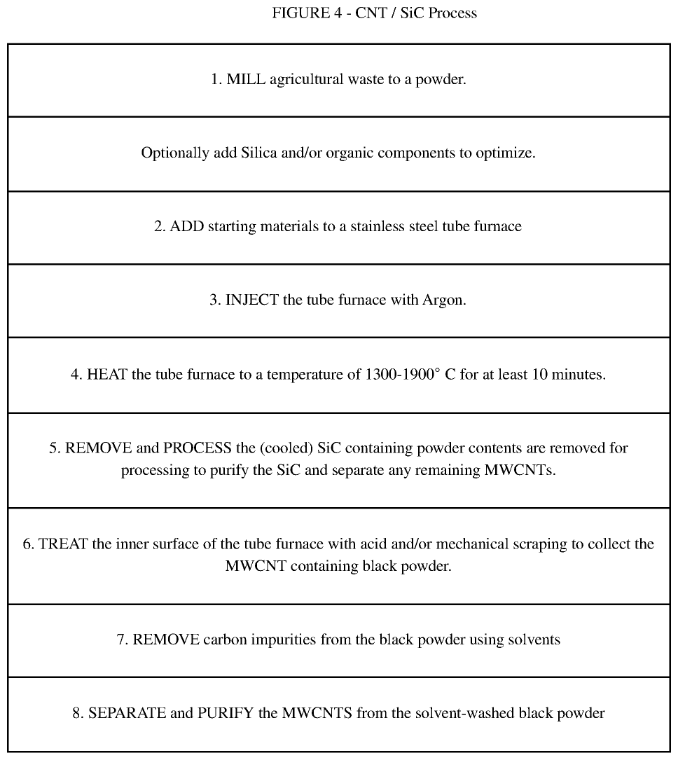

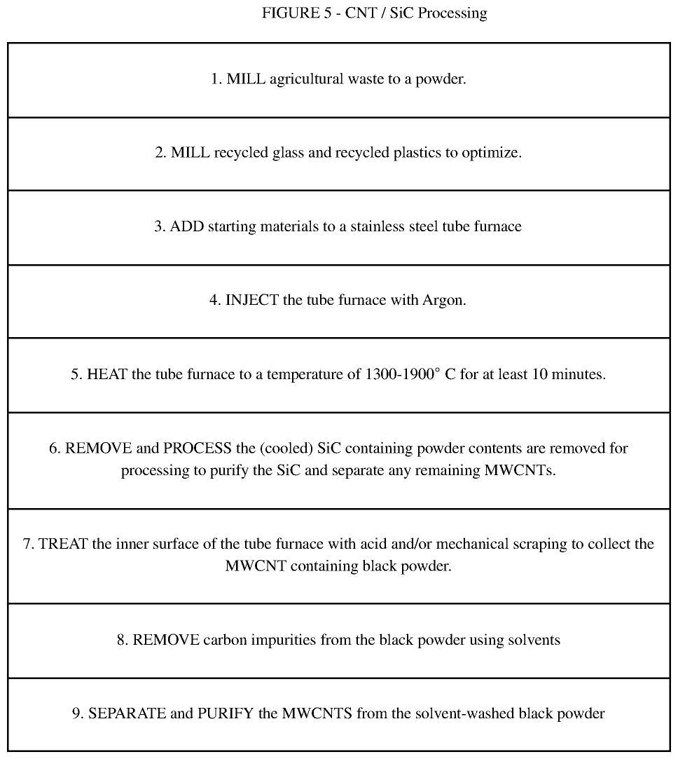

Referring now to FIGS. 4 and 5, the process for producing silicon carbide and multiwalled carbon nanotubes (MWCNTs) includes heating agricultural waste husks in an inert atmosphere to a temperature higher than 1300 degrees C. to obtain a mixture containing silicon carbide and MWCNTs, and treating the mixture to extract MWCNTs and separate the MWCNTS from the silicon carbide.

The agricultural waste husks contain over 90% silica content and are comprised of sugarcane bagasse, rice husks, or a combination of the two.

An extraction step comprises adding to the mixture a dispersant selected from Sodium Dodecyl Sulfonate (SDS), Sodium Dodecyl Benzene Sulfonate (SDBS), Tetrahydrofuran (THF), polyvinylpyrrolidone (PVP), N-methylpyrrolidone (NMP), isopropyl alcohol, or an acid, to separate the MWCNTs from silicon carbide. In other embodiments, the extraction comprises subjecting an output stream of the mixture to an electromagnetic field to separate the MWCNTs from silicon carbide, or comprises centrifuging the mixture in a density gradient matrix to separate the MWCNTs from silicon carbide. In some embodiments, the extraction comprises acid treatment, for example treating the mixture with sulfuric acid, nitric acid, hydrochloric acid, or a mixture thereof, with or without sonication, to functionalize the MWCNTs (—COOH) for dispersion without an aqueous solution, followed by separation of MWCNTs from silicon carbide by filtering and/or centrifuging, and/or treatment with a salt-forming composition such as a base.

In another non-limiting preferred embodiment, the extraction comprises performing a two step extraction of subjecting the mixture to an electromagnetic field to create a first MWCNT extraction product and a first silicon carbide extraction product, followed by separately treating the first MWCNT extraction product and the first silicon carbide extraction product with a dispersant to create second MWCNT extraction products and second silicon carbide extraction products, respectively, and combining the first and second MWCNT extraction products into a purified MWCNT product and combining the first and second silicon carbide extraction products into a purified silicon carbide product.

In another non-limiting preferred embodiment, the extraction comprises separately centrifuging the purified MWCNT product and purified silicon carbide product in a density gradient matrix, and collecting a highly purified MWCNT product and a highly purified silicon carbide product, respectively.

Referring now to FIG. 5, any of the processes described herein may include wherein the heating step includes adding to the agricultural waste husks a silica composition selected from: crushed glass or glass frit, wherein said crushed glass or glass frit is provided at a mass ratio of about 0.75 to about 1.25 of said agricultural waste husks; sand, wherein said sand is provided at a mass ratio of about 0.75 to about 1.25 of said agricultural waste husks; silica fume, wherein said silica fume is provided at a mass ratio of about 0.15 to about 0.4 of said agricultural waste husks; silica flour, wherein said silica flour is provided at a mass ratio of about 0.15 to about 0.3 of said agricultural waste husks, and combinations thereof.

Any of the processes described herein may include wherein the inert atmosphere is a vacuum atmosphere, a nitrogen atmosphere, or an argon atmosphere.

Any of the processes described herein may include wherein the heating step includes adding an organic component selected from carbon monoxide, compounds containing C2-C18 alkyl, alkenyl, or aryl groups such as hydrocarbon gases, liquids, or oils, plastics, and plastic waste.

Any of the processes described herein may include wherein the heating step is performed in a flow reactor.

Any of the processes described herein may include wherein the heating step is performed in a flow reactor, wherein the flow reactor is a reactor vessel and a catalyst, and wherein the flow reactor includes a steel tube.

The terminology used herein is for the purpose of describing particular embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

The embodiments herein, and/or the various features or advantageous details thereof, are explained more fully with reference to the non-limiting embodiments that are illustrated in the accompanying drawings and detailed in the following description. Descriptions of well-known components and processing techniques are omitted so as to not unnecessarily obscure the embodiments herein. Like numbers refer to like elements throughout.

The examples and/or embodiments described herein are intended merely to facilitate an understanding of structures, functions, and/or aspects of the embodiments, ways in which the embodiments may be practiced, and/or to further enable those skilled in the art to practice the embodiments herein. Similarly, methods and/or ways of using the embodiments described herein are provided by way of example only and not limitation. Specific uses described herein are not provided to the exclusion of other uses unless the context expressly states otherwise.

### Definitions

The term “ultra-high performance concrete” (UHPC) refers to compositions made by the processes described here, and may further include the addition of aggregate to the cement paste.

The term “curing” refers to the process of applying heat and hydration, either humidity or submersion in water, to harden a poured (in situ) or formed (pre-cast) UHPC article. The curing process increases the strength of the UHPC. For example, curing can increase a UHPC article from 10,000 psi to over 20,000 or 50,000 psi. Heating can be applied using standard thermal means and can also be applied using voltage heating where CNTs are intermixed with UHPC.

The term “psi” refers to pounds per square inch, and is synonymous with megapascal, abbreviated MPa. The conversion units between MPa and psi is that 1 MPa=145.0377 psi, and 1000 psi=6.894757 MPa.

The term “voltage heating” refers to the process of applying a voltage, e.g. 40V, to an article of UHPC having CNT and/or steel microfibers. The voltage can be applied using wire connectors that are directly connected to the CNTs and/or steel microfibers. Such voltage heating can be used in curing the UHPC, but can also be used on a finished product to generate a heated UHPC component, such as a heated floor tile, a heated wall panel, a heated roofing tile, a heated sidewalk, a heated bridge deck, etc. without intending to be limited.

The term “admixture” or “admix” refers to chemicals and/or minerals that are used to improve the behavior of concrete under a variety of conditions. Chemical admixtures are used to improve the quality of concrete during mixing, transporting, placement and curing. Chemical admixtures can be categorized as follows: air entrainers; water reducers; set retarders; set accelerators; superplasticizers; and specialty admixtures, which include corrosion inhibitors, shrinkage control, alkali-silica reactivity inhibitors, and coloring.

ASTM C494 specifies the requirements for seven chemical admixture types. They are:
Type A: Water-reducing admixtures
Type B: Retarding admixtures
Type C: Accelerating admixtures
Type D: Water-reducing and retarding admixtures
Type E: Water-reducing and accelerating admixtures
Type F: Water-reducing, high range admixtures
Type G: Water-reducing, high range, and retarding admixtures
Note: Changes occur in the admixture industry faster than the ASTM consensus process. Shrinkage Reducing Admixtures (SRA) and Mid-Range Water Reducers (MRWD) are two areas for which no ASTM C494-98 specifications currently exist.

The term “water reducer” refers to a superplasticizer admixture that is used to: (1) increase slump, (2) lower the water-cement ratio, or (3) reduce cement content. Water reducers range in ability to reduce water from low (achieve a minimum 5% water reduction) to mid-range (reduce water content by at least 8% and as much as 15%) to high-range (reduce water content from 12% to as much as 40%).

Silica Fume: Early Strength and Reduced Permeability Silica fume makes a significant contribution to early-age strength of concrete. One pound of silica fume produces about the same amount of heat as a pound of portland cement, and yields about three to five times as much compressive strength.

Silica fume improves concrete in two ways: the basic pozzolanic reaction, and a microfiller effect. Addition of silica fume improves bonding within the concrete and helps reduce permeability, it also combines with the calcium hydroxide produced in the hydration of portland cement to improve concrete durability.

As a microfiller, the extreme fineness of the silica fume allows it to fill the microscopic voids between cement particles. This greatly reduces permeability and improves the paste-to-aggregate bond of the resulting concrete compared to conventional concrete.

Examples of silica microfiller as contemplated herein:
8% to 15% by weight of cement but as an addition not replacement
8% to 10% High durability/Low permeability such as bridge decks or parking structures
10% to 15% High strength structural columns
10% max Flatwork

The amount required is related to silica fume dosage and the water-cementitious materials ratio. Silica fume is cementitious, but typically is added to and not replacing the existing portland cement.

The higher percentage of silica fume used, the higher the amount of super plasticizer needed. Where a mix becomes “sticky”, the super plasticizer can be partially replaced with a mid-range water reducer to improve workability.

Some examples of preferred uses for silica microfiller include: reduces concrete permeability, increases concrete strength, improves resistance to corrosion, in concrete admixtures that control cracking, and for reducing drying or shrinkage cracking.

Hydrated cement paste shrinks as it loses moisture from its extremely small pores. As the moisture is lost in these small pores, the surface tension of the remaining water tends to pull the pores together which results in a loss of volume over time.

Shrinkage reducing admixtures (SRAs) are designed to decrease the effects of drying shrinkage by reducing the surface tension in these pores.

It should be noted that the type of aggregate and the cement properties themselves can influence the amount of cracking that can occur. Thus, it is important to test local project-specific materials if doing shrinkage testing.

Curing also affects cracking. In slabs, the top tends to dry out first and shrinks while the lower sections still have a higher moisture content. This difference in moisture can be altered by use of Shrinkage Reducing Admixtures, which alter the way water migrates through the concrete and results in a more uniform moisture profile.

### Set Acceleration

Set accelerators work by accelerating cement hydration, which results in shortened setting times and increased early age strengths, particularly in cooler temperatures.

They increase the rate of early strength development and reduce time required for curing and protection

Superplasticizers (High-Range Water Reducers) can make a low-to-normal slump concrete into a high-slump flowing concrete which can be placed with little or no vibration. However, the change in slump usually lasts only about 30 to 60 minutes depending upon the brand and dosage rate.

High-range water reducers fall into either ASTM C494 Type F or Type G classification. In either case, they can be used to produce very high slumps without segregation, an ideal situation where increased flowability is necessary due to congested reinforcement.

Other applications and benefits of high-range water reducers include: difficult wall placements, narrow forms, sections with blockouts, penetrations, or embedded items, pumping high vertical distances, fast placement of concrete, and increased lift heights and free fall distances.

The increased thinness of the concrete mix means that forms should be tight to prevent leakage even through small joints which can result in fins and discoloration.

### Type F Superplasticizers

Added at the job site and keep concrete flowable for a short period of time. At some point, the concrete will lose slump quickly.

### Type G Superplasticizers

Can be added either during batching or at the job site. This admixture will delay setting, but cause the concrete to be flowable for a longer period of time which could delay finishing. If haul times are particularly long, Type G can be added at the plant. However, if delivery is delayed too long, the effects can be diminished. Redosing is possible to regain the plasticity of the mix and manufacturers recommendations should be followed closely.

The term “water reducers” refers to compounds comprising a polyoxyalkyl chain and an amino-alkylene phosphonic group.

Any of the processes and compositions herein may include an admixture comprising polycarboxylate, glutaral with 2-octyl-2H-isothiazol-3-one, 1,2-benzisothiazol-3(2H)-one with methylisothiazolinon, 2,2-iminodietanol with dodecyldimethylamine and formaldehyde, formaldehyde, 1,2-benzisothiazol-3(2H)-one, 5-chloro-2-mtheyl-2H-isothiazol-3-one with 2-methyl-2H-isothiazol-3-one, methylisothiazolinon, decyldimethylamine, and mixtures thereof.

The term “hydraulic binder” means, according to the present invention, a powdery material which, mixed with water, forms a paste which sets and hardens as a result of reactions and hydration processes, and which after curing, retains its strength and stability even under water.

The term “hydraulic composition” means any composition comprising a hydraulic binder. This is, for example, a concrete.

The term “concrete” means a mixture of hydraulic binder, aggregates, water, possibly additives, and possibly mineral additives such as high performance concrete, very high performance concrete, self-compacting concrete, self-leveling concrete, self-compacting concrete, fiber concrete, ready-mix concrete or colored concrete. The term “concrete” also means concretes having undergone a finishing operation such as bush-hammered concrete, deactivated or washed concrete, or polished concrete. According to this definition, prestressed concrete is also meant. The term “concrete” includes mortars, in this case the concrete comprises a mixture of hydraulic binder, sand, water and possibly additives and possibly mineral additions. The term “concrete” according to the invention denotes indistinctly fresh concrete or hardened concrete.

According to the invention the term “aggregates” refers to gravel, chippings and/or sand.

The term “mineral additions” refers to a finely divided mineral material used in concrete to improve certain properties or to confer particular properties. These are, for example, fly ash (as defined in EN 450), silica fumes (as defined in the standard prEN 13263: 1998 or NF P 18-502), slags (such as defined in standard NF P 18-506), calcareous additions (as defined in standard NF P 18-508) and siliceous additions (as defined in standard NF P 18-509).

The term “setting” means according to the present invention the transition to the solid state by chemical reaction of hydration of the binder. The setting is usually followed by the hardening period.

The term “hardening” means according to the present invention the acquisition of the mechanical properties of a hydraulic binder, after the end of setting.

The term “water reducer” means an additive that serves to reduce the amount of water required to produce a concrete of at least 5%. By way of example, water reducing agents based on lignosulfonic acids, carboxylic acid or treated carbohydrates can reduce the water requirements for the production of a concrete by approximately 10% to 15%.

The expression “superplasticizer” or “superfluidifier” or “super water reducer” means a water reducer that reduces by more than 12%, the amount of water required for the realization of a concrete. Superplasticizers have generally been classified into four groups: sulfonated naphthalene formaldehyde condensate (or SNF, acronym for sulphonated naphthalene formaldehyde); sulphonated formaldehyde melamine condensate (or SMF, acronym for sulphonated melamine formaldehyde); modified lignosulphonates (or MLS, modified lignosulfonates); and others. More recent superplasticizers include polycarboxylate (“PC”) polymer dispersant compounds. Some of the PC superplasticizers may have a comb structure comprising at least one main chain and pendant grafts. Such superplasticizers are designated by the acronym PCP. For example, these superplasticizers carry ionic functions of carboxylic and/or sulphonic and/or phosphonic, preferably carboxylic, type at the level of the main chain and pendant links of the polyethylene glycol, polypropylene glycol, copolymer or other preferably water-soluble link type. By the term “polyalkylene oxide polycarboxylate” is meant polycarboxylate main chain comb copolymers having grafted side chains of polyalkylene oxide.

The term “ester level” of a polymer means the proportion of the monomer units of the main chain carrying an ester function defined by the formula below:

O—R₁*

wherein R₁ denotes a group having at least one carbon atom through which it is linked to the ester function and * oxygen atom symbolizes the main chain. R 1 may in particular be an alkyl group or a graft of polyalkylene oxide. The ester level is expressed as a molar percentage and is calculated by dividing the number of ester functions on the main chain by the total number of monomer units on the main chain.

By way of example, the hydraulic binder may be a Portland cement. It can be a CEM I, CEM II, CEM III, CEM IV or CEM V cement according to the “Cement” NF EN 197-1 standard.

The term “SiC” refers to silicon carbide. Industrial production of SiC can be achieved by high temperature treatment of organic materials such as agricultural waste husks.

The term “CNT” refers to carbon nanotubes. In a preferred non-limiting embodiment, the CNTs have a diameter from 20-40 nm and a length from 0.5-40 nm.

The term “MWCNT” refers to multi-walled carbon nanotubes. In a preferred non-limiting embodiment, the MWCNTs have a diameter from 20-40 nm and a length from 0.5-40 nm. Multi-walled carbon nanotubes (MWCNTs) are a special form of carbon nanotubes in which multiple single-walled carbon nanotubes are nested inside one another. MWCNTs have the unique properties that are seen within single-walled and double-walled carbon nanotubes but also have increased dispersability compared to single walled carbon nanotubes, resulting in the reduced cost in synthesis and purification of these materials.

The term “agricultural waste” refers to rice husk, sugarcane bagasse, or other silica containing agricultural waste such as waste from sorghum, peanuts, walnuts, almonds, pistachios, nut shells, map fruit pits such as from dates, peaches, mango, and corn husk materials. In a preferred embodiment, rice husks contain 90-98% silica composition, and sugarcane bagasse contains about 92% silica composition. Other waste products may require additional silica be added to the process to obtain the desired silicon carbide product, in desired ratio with the carbon nanotube containing soot product.

In some embodiments, the agricultural waste bulk starting material may require grinding or milling the agricultural waste into a fine powder. Flow agents may also be added to facilitate loading of the agricultural waste into the reaction vessel. The agricultural waste may also be pelletized with or without a binder for bulk processing.

The term “organic component” refers to the carbon component of the agricultural waste as well as any carbon containing additive that is added to the agricultural waste to include the MWCNT product. Examples of added organic components (added to the agricultural waste) include carbon monoxide, compounds containing C2-C18 alkyl, alkenyl, or aryl groups such as hydrocarbon gases, liquids, or oils, plastics, and plastic waste. Plastic waste includes polypropylene

The term “heating”, relating to the production of SiC and CNT, refers to vacuum oven-heating, microwave heating, or flow reaction heating to achieve producing silicon carbide and MWCNT from the starting materials. In a preferred embodiment, microwave heating may be used, and may include using a 50-100 GHz beam, preferably 83 GHZ, with a total beam power of 2-10 kW, preferably 5 kW.

The term “temperature” refers to temperatures and conditions that result in the conversion of the starting materials to SiC and MWCNTs. Typical ranges of temperatures for converting agricultural waste to SiC include 1300°-1900° C.

Any of the processes herein may include heating conditions that include a vacuum environment, an Argon atmosphere, a Nitrogen atmosphere, or a mixture of gases. The time for heating includes a range from 2-15 minutes, and more preferably from 6-15 minutes, and even more preferably from 8-10 minutes.

The term “purification” or “separation” refers to a process for separating the mixture product that is formed by the inventive process, and refers to one or more processes for separating the SiC product and the MWCNT product.

### Example—Purification of MWCNT

Referring again to FIGS. 4 and 5, a typical purification process is as follows: 1 kg MWCNTs in 20 kgs of 20% HNO³ solution at 80-90° C. for 6 hrs, then it is repeatedly filtered, DI water washed, and filtered until the filtrate solution is PH neutral. The MWCNTs are then dried until the form a cake. It is then broken up into a fine powder. MWCNTs made from this process will form a colloidal suspension in solvents. They can be deposited on substrates, or further manipulated in solution, and can have many different functional groups attached to the MWCNTs

The term “dispersant” refers to a liquid that evenly disperse the MWCNT within the liquid matrix, with or without sonication. Examples of dispersants include Sodium Dodecyl Sulfonate (SDS), Sodium Dodecyl Benzene Sulfonate (SDBS), Tetrahydrofuran (THF), polyvinylpyrrolidone (PVP), N-methylpyrrolidone (NMP), isopropyl alcohol, sulfuric acid, nitric acid, hydrochloric acid, hydrogen peroxide, or a mixture of acids such as sulfuric and nitric acids.

The term “silica” refers to silicon dioxide. Silica fume refers to pyrogenic silica because it is produced in a flame, consists of microscopic droplets of amorphous silica fused into branched, chainlike, three-dimensional secondary particles which then agglomerate into tertiary particles. The resulting powder has an extremely low bulk density and high surface area. Silica flour refers to finely ground, nearly pure silicon dioxide.

In a preferred process, silica in the form of glass, glass frit, sand, silica fume, and/or silica flour is added to the agricultural waste.

The term “magnetic separation” refers to the use of an electro-magnetic field which is applied to a reaction stream to separate MWCNT from SiC on the basis of their inherent or functionalized magnetic properties.

The term “flow reaction tube” refers to a metal tube reaction vessel that may contain one or multiple stages, where each stage may have the same or separate atmosphere, pressure, and temperature. In a preferred embodiment, the metal tube is stainless steel in order to catalyze, using Fe and Ni, the formation of MWCNTs as soot along the inner surface within the lumen of the metal tube.

### Example—SiC/CNT Process

Referring now to FIG. 4, FIG. 4 shows a non-limiting preferred embodiment wherein, first, the agricultural waste is milled to a powder. Silica and/or organic components are added to optimize production of SiC and MWCNTs. This starting material is added to a stainless steel tube furnace and the atmosphere is converted to a vacuum or to an argon atmosphere. The tube furnace is heated to a temperature of 1300-1900° C. for at least 10 minutes. The tube furnace is cooled and the SiC containing powder contents are removed for processing to purify the SiC and separate any remaining MWCNTs. The inner surface of the tube furnace is treated with acid and/or mechanical scraping to remove the MWCNT containing black powder. Solvents may be used to remove carbon impurities such as fullerenes. Additional processing of the MWCNT containing black powder is performed to purify the MWCNTs from the black powder.

Example—Process with Recycled Plastic and Recycled Glass

Referring now to FIG. 5, wherein FIG. 5 shows another non-limiting preferred embodiment wherein first, the agricultural waste is milled to a powder. Recycled glass is milled to a powder and recycled plastics are shredded and/or ground to a powder. The recycled glass powder and the recycled plastic powder are added to the milled agricultural waste powder in a ratio to optimize production of SiC and MWCNTs. This starting material is added to a stainless steel tube furnace and the atmosphere is converted to a vacuum or to an argon atmosphere. The tube furnace is heated to a temperature of 1300-1900° C. for at least 10 minutes. The tube furnace is cooled and the SiC containing powder contents are removed for processing to purify the SiC and separate any remaining MWCNTs. The inner surface of the tube furnace is treated with acid and/or mechanical scraping to remove the MWCNT containing black powder. Solvents may be used to remove carbon impurities such as fullerenes. Additional processing of the MWCNT containing black powder is performed to purify the MWCNTs from the black powder.

Example—Use of Microinclusions (mwCNTs, SiC, UHMWPE) in Ultra High Performance Concrete

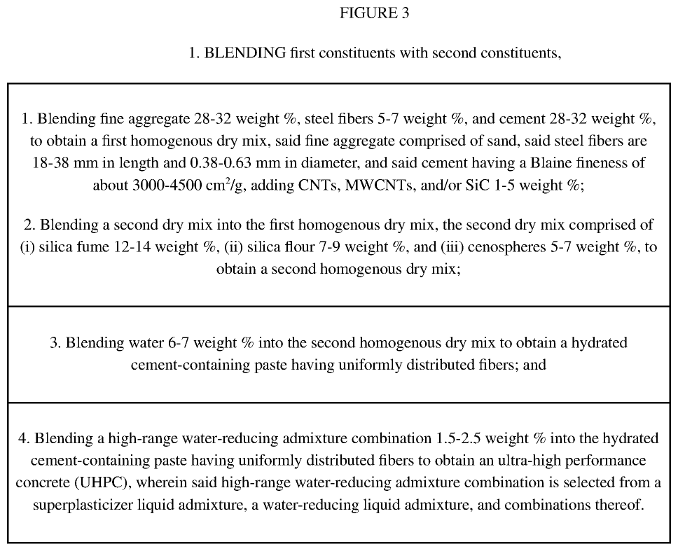

Referring now to FIG. 3, MWCNTs made according to the invention herein can be used in the manufacture of UHPC. In one non-limiting example, the composition and method may comprise blending a group of first constituents that are dry-blended with microinclusions, followed by mixing with a group of second constituents.

For UHPC, first constituents may comprise (i) cement of Blaine fineness of about 280 to about 360 m2/kg; (ii) sand, wherein said sand is provided at 28-32% by weight of said UHPC; (iii) silica fume, wherein said silica fume is provided at 11-14% by weight of said UHPC; (iv) silica flour, wherein said silica flour is provided at 6-9% by weight of said UHPC; (v) microinclusions, wherein said microinclusions are provided at a mass ratio of up to about 0.35 of said cement, and wherein said first constituents are mixed to yield a dry homogeneous mix; and wherein wet constituents comprise (vi) water; and (vii) at least one high-range water-reducing admixture; wherein said water is provided at a mass ratio of about 0.2 to about 0.35 of said cement, and wherein said water is blended into said first homogeneous mix to form a uniform cement-containing paste, and said high-range water-reducing admixture is added after the water to control the reaction; wherein said microinclusions are provided at a mass ratio of up to about 0.35 of said cement, and wherein said microinclusions are blended into said uniform cement-containing paste such that said microinclusions are distributed approximately uniformly in a resultant cement-containing paste, and wherein said resultant cement-containing paste is hydrated.

Surprisingly, it has been found that it is important for the microinclusions to be dry-blended with the first constituents to ensure the proper dispersion of the microinclusions within the resultant composition and to obtain homogeneity of the mixed components.

Any of the UHPC embodiments may include wherein the microinclusions can also include plasma treated recycled steel fibers, wherein the microinclusions are cleaned by plasma treatment to remove organic contamination, remove surface oxides, increase surface hydrophilic property, and improve adhesion, wherein the plasma treatment is selected from the group consisting of: Argon plasma micro-sandblasting, Hydrogen plasma treatment for removal of surface oxides on the recycled steel fibers, Helium plasma treatment, Nitrogen plasma treatment, and Oxygen plasma treatment; wherein the microinclusions are surface-modified by plasma treatment using plasma enhanced chemical vapor deposition to coat the microinclusions with one or more layers selected from the group consisting of: carbon, silicon, carbon nanotubes, silicon carbide, silicon nitride, and mixtures thereof; wherein the microinclusions are surface energy modified by plasma treatment to have one or more ultra-thin layers of a film that adjusts wetting properties to improve of the wettability and increase the mixability of the microinclusions in the composition.

Any of the UHPC embodiments may include microinclusions, wherein said microinclusions are mixed with said first constituents to yield said first homogeneous mix, including wherein said material for formation of said microinclusions are selected from the group consisting of: metals, alloys, steel, synthetics, polymers, natural inorganics, minerals, glass, asbestos, carbon, cellulose, synthetic organics, natural organics, sisal, and combinations thereof.

Any of the UHPC embodiments may include wherein said cement is portland cement with a calcium to silica ratio of less than about 3.1, wherein said silica fume is at least 96% silica with a maximum carbon content of less than about 4%, and wherein said silica flour is crushed silica of less than about 40 microns in its longest dimension.

Any of the UHPC embodiments may include wherein said microinclusions are of lengths between about 18 to about 38 mm and in diameters between about 0.38 to about 0.63 mm, wherein said microinclusions incorporate ends selected from the group consisting of: hooked ends, approximately straight ends, bulbed ends, and combinations thereof, wherein said microinclusions have a surface selected from the group consisting of: silica fume bonded to said surface, glass frit bonded to said surface, a roughened surface, and combinations thereof, and wherein may include microinclusions selected from the group consisting of: fiber microinclusions, spherical microinclusions, polyhedron microinclusions, and combinations thereof, and/or wherein said microinclusions have a longest dimension from about one micron to about 150 microns, and/or nanoinclusions that are included in said first constituents to yield said first homogeneous mix, and/or wherein said nanoinclusions are selected from the group consisting of: fiber nanoinclusions, spherical nanoinclusions, polyhedron nanoinclusions, and combinations thereof, and/or said nanoinclusions are fabricated are selected from the group consisting of: carbon nanotubes, colloids, colloidal silica, and combinations thereof, and/or said microinclusions are fabricated are selected from the group consisting of: metals, ceramics, organics, natural inorganics, natural minerals, synthetics, and combinations thereof, and/or said microinclusion materials are selected from the group consisting of: steel shavings, ceramic whiskers, ceramic spheres, mineral fibers, wollastonite, carbon fibers and combinations thereof.

Any of the UHPC embodiments may further comprising mats of steel strands of diameter less than about 2.5 mm affixed to a tensile-load carrying face of said structure.

Any of the UHPC embodiments may include wherein high-range water-reducing admixture comprises polycarboxylates, wherein said amount is in the range of about three to about 20 fluid ounces per 100 lb of said resultant cement-containing paste.

Any of the UHPC embodiments may include wherein said cement-containing paste is a stiff dough with approximately zero slump, or wherein said cement-containing paste is a flowable mixture.

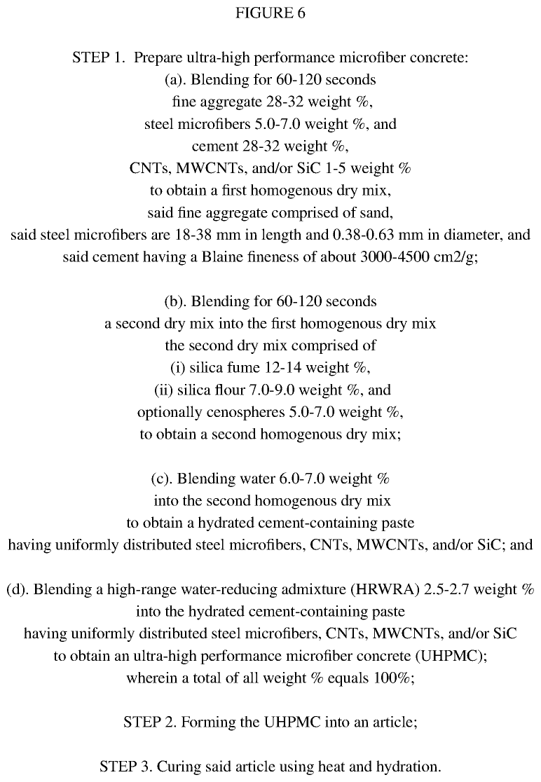

Referring now to FIG. 6, the process of forming an article is provided. Any of the UHPC embodiments may include STEP 1. Prepare ultra-high performance microfiber concrete: (a). Blending for 60-120 seconds, fine aggregate 28-32 weight %, steel microfibers 5.0-7.0 weight %, and cement 28-32 weight %, CNTs, MWCNTs, and/or SiC 1-5 weight %, to obtain a first homogenous dry mix, said fine aggregate comprised of sand, said steel microfibers are 18-38 mm in length and 0.38-0.63 mm in diameter, and said cement having a Blaine fineness of about 3000-4500 cm2/g; (b). Blending for 60-120 seconds a second dry mix into the first homogenous dry mix, the second dry mix comprised of (i) silica fume 12-14 weight %, (ii) silica flour 7.0-9.0 weight %, and optionally cenospheres 5.0-7.0 weight %, to obtain a second homogenous dry mix; (c). Blending water 6.0-7.0 weight % into the second homogenous dry mix to obtain a hydrated cement-containing paste having uniformly distributed steel microfibers, CNTs, MWCNTs, and/or SiC; and (d). Blending a high-range water-reducing admixture (HRWRA) 2.5-2.7 weight % into the hydrated cement-containing paste having uniformly distributed steel microfibers, CNTs, MWCNTs, and/or SiC to obtain an ultra-high performance microfiber concrete (UHPC or microfiber UHPC or UHPMC); wherein a total of all weight % equals 100%;

And STEP 2. Forming the UHPMC into an article; STEP 3. Curing said article using heat and hydration.

Any of the UHPC embodiments may include wherein the cement structure is a component selected from the group consisting of: plates, channels, pipes, tubes, I-beam sections, H-beam components, WF-sections, smooth columns, fluted columns, connectors, panels, endcaps, overlays, wall panels, roofing tiles, floor tiles, underflooring, wall tiles, stepping stones, planters, trusses, joists, rafters, support gussets, decking, footers, mounting pads, precast water conduit, precast sewage pipes, precast pipe connectors, bricks, refractory bricks, fireplace liners, veneers, oil and gas well cementing for casings, seawalls, sea barrier blocks and forms, undersea pilings, undersea mounting pads, harbor docks, precast highway slabs, precast railroad ties, precast parking blocks, precast jersey barriers, street curbs, sidewalks, driveway aprons, countertops, laboratory bench tops, warehouse flooring slabs, power station towers, power station dams, and combinations thereof.

Any of the embodiments herein may include wherein said components are employed to fabricate items selected from the group consisting of: vehicle up-armoring, ballistic armor, blast-resistant panels, man-portable panels, thin armor panels, forced entry resistant structural elements, armored roofing tiles, ballistic wall panels, ballistic floor tiles, hurricane and tornado resistant structural elements, and combinations thereof.

Any of the methods of making UHPC forms may be made by techniques selected from the group consisting of: spin casting, extrusion molding, pressure molding, pouring into forms, and combinations thereof.

Any of the method of making UHPC forms wherein said composition component is cured by: placing in an environment of approximately 100% relative humidity for about seven days at ambient temperature, submersing in water of approximately 85° C. to about 91° C. for about three to about five days, and heating in air at approximately 85° C. to about 91° C. for about one to about two days, wherein, said cured composition component becomes crystalline unlike said composition components cured under ambient conditions as an amorphous calcium silicate hydrate.

### Plasma Treatment

Any of the fibers used herein may be subject to plasma etching treatment. Plasma treatment is a surface modification technique that readily primes any surface for better acceptance of secondary manufacturing applications. Plasma is a reactive treatment process where positive and negative ions, electrons, and radicals react and collide as long as an electric potential difference exists. Some plasma treatments use low pressure, or vacuum plasma, for more consistent and longer-lasting surface treatments. By plasma treating fibers, the invention provides microscopically changed surfaces for improved bonding, micro-cleaned fibers to enhance the surface wetting of adhesives or over-molded elastomers, functionalized groups (carbonyl, hydroxyl and others) to improve surface energy, and the establishment of hydrophobic and hydrophilic properties.

### Plasma Cleaning

Plasma cleaned fibers avoids the use of environmentally unfriendly cleaning chemicals in addition to e.g. trichloroethylene. Plasma cleaning offers significant advantages over wet cleaning methods alone and removes organic contamination, renders surfaces more hydrophilic, and improves adhesion.

Argon plasma micro-sandblasting is contemplated as a plasma treatment herein. Hydrogen plasma plasma treatment is also contemplated for removal of surface oxides on the recycled steel fibers. Helium, Nitrogen, and Oxygen plasma treatments are included within the scope of the invention.

### Plasma CVD Surface Modification

Functionalized groups can be added to the cleaned surface of the fibers using plasma enhanced chemical vapor deposition to coat the fibers with layers of carbon, silicon, carbon nanotubes, silicon carbide, silicon nitride, and so forth.

### Plasma Wetting Layer

Improving wettability of the fibers is also an aspect of plasma treatment included herein. Use of plasma treatment to modify the surface energy of the surface of the fibers increases the mixability of the fibers in the composition. Examples of modifying the surface energy includes deposition of ultra-thin layers by plasma to adjust wetting properties, using siloxane-based or fluorocarbon films.

### Composition Toughness

In select embodiments of the present invention, structures and components are built using a superior composition, providing a combination of high strength and superior energy absorbing capacity. Toughness is a measure of the amount of energy required to be expended to open cracks in the matrix under tensile loading. It is an important metric for objects that suffer impact.

Select embodiments of the present invention provide formulations and methods of fabrication for producing an optimum combination of increased strength and toughness in a custom composition that may be formulated with plasma treated fibers.

### Consistency Modifiers

Select embodiments of the present invention may incorporate high-performance materials such as woven mats of small diameter high-strength wire comprising steel or synthetics such as carbon fiber, fiberglass, and aramids, to further enhance performance. In select embodiments of the present invention, un-hydrated cement-based paste may be mixed in a “dough-like” consistency enabling it to be extrusion molded, spun-cast, or formed under external pressure into shapes suitable for protective applications, such as components for improving blast resistance of structures, for fabricating inexpensive alternatives to ceramic armor, and the like. This stiff mixture holds its shape during production and curing without the need of formwork, enabling it to be produced on an assembly line.

Because of superior performance, select embodiments of the present invention are suitable for commercial use as structural members and resistant panels. Select embodiments of the present invention obtain superior strength and toughness qualities through, among other considerations, proper selection of the type and quantity of constituents, including macro-, micro- and nano-sized inclusions of specified composition.

Macro- and microfiber reinforcement contributes to an optimum combination of strength and toughness. Macro-fibers address bridging of macro-cracks and micro-fibers address bridging of micro-cracks.

### Example—Specific Mixtures

Initial mixes of select embodiments of the present invention comprise: a cement of Blaine fineness at about 280 to about 360 m2/kg; sand at a mass ratio of about 0.75 to about 1.25 of the mass of cement; silica fume at a mass ratio of about 0.15 to about 0.4 of the mass of cement; silica flour at a mass ratio of about 0.15 to about 0.3 of the mass of cement; at least one high-range water-reducing admixture (HRWRA), such as GLENIUM® 3030 NS, Degussa Admixtures, Inc.; ADVA® 170 and ADVACAST® 500, W.R. Grace & Co., and PLASTOL, EUCON 37 and EUCON 1037, Euclid Chemical Co., in amounts approximately commensurate with the recommendations of the manufacturer; plasma treated fibers.

### Optional Additional Fibers

Besides carbon nanotube fibers, optional additional fibers include mineral fibers (e.g., glass or asbestos), optional synthetic organic fibers (e.g., carbon, cellulose, or polymeric), optional natural organic fibers (e.g., sisal) at a mass ratio of up to about 0.35 of the mass of cement; and water at a mass ratio of about 0.2 to about 0.35 of the mass of cement.

In select embodiments of the present invention, an HRWRA may be added in specified amounts of about 3-20 fluid ounces per 100 lbs of the cement-based paste.

### Example—Mix Variations

For select embodiments of the present composition, constituents may vary within the initial mix. For example, the cement may be portland cement of high-silica content, i.e., a calcium to silica ratio (Ca/Si) of less than about 3.1. Silica fume may be incorporated, of preferably at least 96% silica with a carbon content of less than about 4%. Silica flour may be incorporated, preferably as pure, finely crushed silica of less than about 40 microns. microinclusions consist of plasma treated fibers.

The composition may also contain optional synthetic fibers, polymer fibers, organic fibers, natural inorganic fibers, and the like, and combinations thereof.

### Microinclusion Size

Preferably, microinclusions are provided in lengths between about 18 to about 38 mm (0.75-1.5 in.) and in diameters between about 0.38 to about 0.63 mm (0.015-0.025 in.). The ends of the microinclusions may be hooked, straight, or “bulbed.” Special treatment of the microinclusions, such as bonding silica fume or glass frit to the surface or roughening the surface, enhances the bond between the cement-based paste and the microinclusions.

Mats comprising continuous, high-strength steel strands of diameter less than about 2.5 mm (0.1 in.) may be embedded in or bonded to the tensile-load carrying face of the mix to add strength and toughness. The high-range water-reducing admixture (HRWRA) may be a polycarboxylate type material, added in amounts approximating recommendations of the manufacturer.

### Inclusions

In select embodiments of the present invention, microinclusions, also termed dispersions, are incorporated to increase the toughness of the mix (cement-based paste) at the micro (or nano) scale by acting as micro-crack bridging mechanisms that truncate or delay the growth of micro cracks in the mix and at the nanoscale by filling the void spaces between larger particles making the material more dense. Microinclusions may be selected from the group comprising: fiber-like microinclusions, spherical microinclusions, polyhedron microinclusions, fiber-like nanoinclusions, spherical nanoinclusions, polyhedron nanoinclusions, and the like, and combinations thereof. In select embodiments of the present invention, microinclusions may have a longest dimension from about one micron to about 150 microns.

Microinclusions may be selected from the group of materials comprising: metals, ceramics, organics, natural minerals, and the like, and combinations thereof. Specific configurations of these microinclusion materials may be selected from the group comprising: steel shavings, ceramic whiskers, ceramic spheres, mineral fibers, wollastonite, carbon fibers, carbon nanotubes, and the like, and combinations thereof. Further, microinclusions may be selected from the class of materials of a colloidal nature such as colloidal silica.

### Flow Modifiers

In select embodiments of the present invention, the rheology of the constituents in the mix may range from highly flowable to that of stiff dough or clay, depending on the concentration of each of the constituents. The rheology of a particular mix is dependent on the volume and surface area of dry constituents (including the microinclusions and select nanoinclusions), the volume of water, and the mass of the HRWRA used. For example, a stiff dough-like mixture suitable for extruding or spin-casting contains a relatively high volume of dry constituents, a relatively low volume of water and a relatively moderate to low mass of an HRWRA. Conversely, a flowable mixture contains a relatively low volume of dry constituents, a relatively high volume of water and a relatively high mass of an HRWRA.

For mixing select embodiments of the present invention, equipment for making “stiff” mixtures comprises a shear-type mixer, such as a paddle or star-wheel mixer. These impart high-shear energy to the wetted constituents, readily converting them into a cement-based paste, albeit a stiff paste. The greater the shear-imparting energy imparted to the constituents in mixing, the quicker they form into a cement-based paste. For mixing select embodiments of the present invention, equipment for making “flowable” mixtures may be conventional drum-type mixers or the above high-shear mixers.

### Example—Blending Process

In select embodiments of the present invention, the process comprises loading dry constituents, including microinclusions, such as microfibers and nanofibers, into the bowl of the mixer and first blending them in the dry state for about ten minutes. The water is then added first to the dry ingredients as the mixer is operating, and the admix is added after the water to control the reaction. Mixing continues to yield a homogeneous cement-based UHPC paste.

In select embodiments of the present invention, the wet mixing may consume an hour depending on the amount of shear energy being imparted to the mixture and the volume of water and mass of the HRWRA added to wet the dry constituents. The mixture becomes a “homogenized” paste when no more individual particles are visible and the components in the mixer have come together as a single mass of cement-based paste having no separately distinguishable components. At this point, for select embodiments of the present invention, microinclusions may be added and blended for ten minutes to allow them to distribute evenly.

### COMPARATIVE EXAMPLES

| Type of composition | psi | invention |
|---|---|---|
| Mortar | 1200 | |
| Concrete | 3000-4000 | 12,000+ |

| Failures | psi | invention | UHPC psi |
|---|---|---|---|
| Wrong admix | 6000-7000 | Correct admix | 12,000+ |
| Lacking Si Fume/Flour | 3000-4000 | incl. Si Fume/Flour | 12,000+ |
| Lacking cenospheres | 3000-4000 | opt. cenospheres | |
| Lacking steel microfibers | 6000 | incl. Steel microfibers | 12,000+ |
| Large macro fibers | 4000 | macroinclusions | 12,000+ |
| Wrong sand, impurities | <3000-4000 | clean, sized sand | 12,000+ |
| Mixing admix before water | 4000 | correct process | 12,000+ |
| Blend all in one | clumps, amorphous | correct sequence | 12,000+ |
| Lacking CNT | 3000-4000 | incl. CNT | 12,000+ |
| Not curing | 3000-4000 | incl. CNT + 40 V | 30,000-50,000 |
| | | Joule heating | |
| Using chloride admix | <3000 (oxidizes) | | |
| Large aggregate | 3000-4000 large pores, | | |
| | too porous | | |

### Example—Molds and Forms

Referring again to FIG. 6, in select embodiments of the present invention, the cement-based paste is placed in molds to hydrate (harden). In select embodiments of the present invention, the molding procedure depends on the rheology of the final cement-based paste. Flowable cement-based pastes are placed or poured into molds that contain the cement-based paste until it hydrates.

In select embodiments of the present invention, fluid cement-based paste may be vibrated by placing molds filled with cement-based paste on an external vibrating table and vibrating the mold and cement-based paste as a unit, or by inserting internal vibrators into the cement-based paste and vibrating until it is consolidated. Vibration frees entrapped air voids from the cement-based paste and consolidates solid constituents into a tightly packed configuration.

In select embodiments of the present invention, “stiff” mixtures of the cement-based paste are shaped by pressure molding, extrusion molding, or spin casting. In select embodiments of the present invention, pressure molding comprises rolling or pressing a dough-like cement-based paste into a prepared mold or pressing a dough-like cement-based paste to a given thickness as in the case of making plates or tiles. In select embodiments of the present invention, placing a dough-like cement-based paste into an extruder and applying pressure to force it through the die yields a final molded shape. Extruded product may need to be supported until it hardens to prevent it from changing shape. In select embodiments of the present invention, spin casting involves placing a dough-like cement-based paste along the longitudinal axis of the inside of a mold and spinning the mold at high speed to distribute the cement-based paste evenly over the inside of the mold with the centrifugal force created by the spinning.

In select embodiments of the present invention, the molded, extruded or spun-cast cement-based paste is left in the mold or supported in the extruded or spun-cast shape until it has hydrated. This is normally 24 hours, but may be longer depending on the amount of the HRWRA specified for the formulation. In select embodiments of the present invention, product is not removed from the mold until it has achieved a stiffness that resists deformation under moderate force, such as thumb pressure.

### Example—Curing

Referring to FIG. 6, in select embodiments of the present invention, curing may be done by conventional methods such as water curing or by applying a curing compound for the same length of time as conventional cement-based paste is cured. However, conventional curing methods may not yield an optimum combination of strength and toughness. To achieve a desired combination, in select embodiments of the present invention, the hydrated but not fully cured, cement-based paste is heated. In select embodiments of the present invention, prior to heating, the cement-based paste is cured for about seven days in an environment of approximately 100% relative humidity at ambient temperature, approximately 21° C.±3° C. (70° F.±5° F.), submersed in water at approximately 88° C.±3° C. (190° F.±5° F.) for about three to about five days, and heated in air at approximately 88° C.±3° C. (190° F.±5° F.) for about one to about two days. This process configures amorphous calcium silicate hydrate as a structure that is more like a crystalline structure than the original amorphous calcium silicate hydrate.

As shown, select embodiments of the present invention provide a composition that is both strong and tough for fabricating superior building components. These superior components may be made in any shape through form casting while conventional structural shapes may be made by either mold extrusion or spin-casting.

### Example—Voltage Curing—CNT Heated Panels and Forms

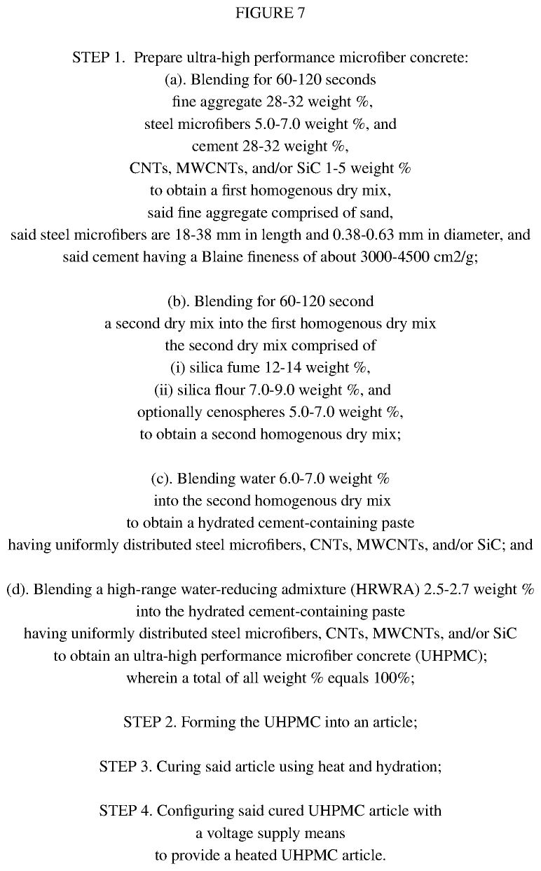

Referring now to FIG. 7, for commercial or residential users: embedding carbon nanotubes (CNTs) and steel microfibers in UHPC and creating a homogenously distributed CNT-microfiber-UHPC provides an opportunity to configure a voltage supply to the CNT-microfiber-UHPC to provide voltage curing of the embedded CNTs.

Additionally, after curing, configuring a voltage supply to the cured CNT-microfiber-UHPC provides a heat-producing CNT-microfiber-UHPC article.

In a preferred embodiment, the CNTs are amorphously cross-linked with steel microfibers in a UHPC+steel fiber+CNT component. In one preferred aspect, the concentration of CNT and steel microfiber in the UHPC ranges from 4-8% steel microfiber, preferably 6%, and 2-4% CNT, preferably MWCNTs from agricultural sources at 2%.

In another preferred embodiment, the UHPC includes a voltage delivery mesh or feeder wires to provide voltage to CNTs that are cross-linked with steel microfibers in a mesh-fed UHPC+steel fiber+CNT component.

Components include: building construction products, such as roofing tiles, wall panels, floor tiles, and the like, and lightweight structural shapes such as plates, channels, pipes, tubes, I- and WF-sections, and the like.

### Example—Use as Armor

Select embodiments of the present invention are suitable for fabricating inexpensive structural panels, such as thin armor panels that may be used for vehicles as well as fixed structures. Structural armor panels may be formed or extruded to a thickness heretofore impractical because of the improved toughness and strength of embodiments of the present invention. For example, panels may be produced in size and thickness to accommodate man-portability. These man-portable panels may be configured for attaching to a structural framework to resist penetration of small arms fire and mitigate blast and fragmentation effects.

An embodiment of the present invention, configured appropriately, offers an inexpensive solution for force protection in addition to man-portable products. For the military and government applications: very high performance composition incorporated in inexpensive ballistic armor; light weight structural shapes such as plates, channels, pipes, tubes, I- and WF-sections; connectors; protective construction; blast-resistant panels; fragmenting munitions protection; vehicle up-armoring; forced entry resistant structural elements and the like.

### Example—Commercial Construction

For commercial or residential construction, the microfiber UHPC is used to manufacture components are selected from the group consisting of: plates, channels, pipes, tubes, I-beam sections, H-beam components, WF-sections, smooth columns, fluted columns, connectors, panels, endcaps, overlays, wall panels, roofing tiles, floor tiles, underflooring, wall tiles, stepping stones, planters, trusses, joists, rafters, support gussets, decking, footers, mounting pads, precast water conduit, precast sewage pipes, precast pipe connectors, bricks, refractory bricks, fireplace liners, veneers, oil and gas well cementing for casings, seawalls, sea barrier blocks and forms, undersea pilings, undersea mounting pads, harbor docks, precast highway slabs, precast railroad ties, precast parking blocks, precast jersey barriers, street curbs, sidewalks, driveway aprons, countertops, laboratory bench tops, warehouse flooring slabs, power station towers, power station dams, and combinations thereof.

Additional components may be manufactured to fabricate items selected from the group consisting of: vehicle up-armoring, ballistic armor, blast-resistant panels, man-portable panels, thin armor panels, forced entry resistant structural elements, armored roofing tiles, ballistic wall panels, ballistic floor tiles, hurricane and tornado resistant structural elements, and combinations thereof.

### Example—CNT Heated Panels and Forms

Referring again to FIG. 7, for commercial or residential users: adding carbon nanotubes (CNTs) to UHPC and creating a homogenously distributed CNT-UHPC can be connected to a voltage supply to generate voltage heating of the embedded CNTs and provide heated UHPC-CNT components.

In a preferred embodiment, the CNTs are amorphously cross-linked with steel microfibers in a UHPC+steel fiber+CNT component.

In another preferred embodiment, the UHPC includes a voltage delivery mesh or feeder wires to provide voltage to CNTs that are cross-linked with steel microfibers in a mesh-fed UHPC+steel fiber+CNT component.

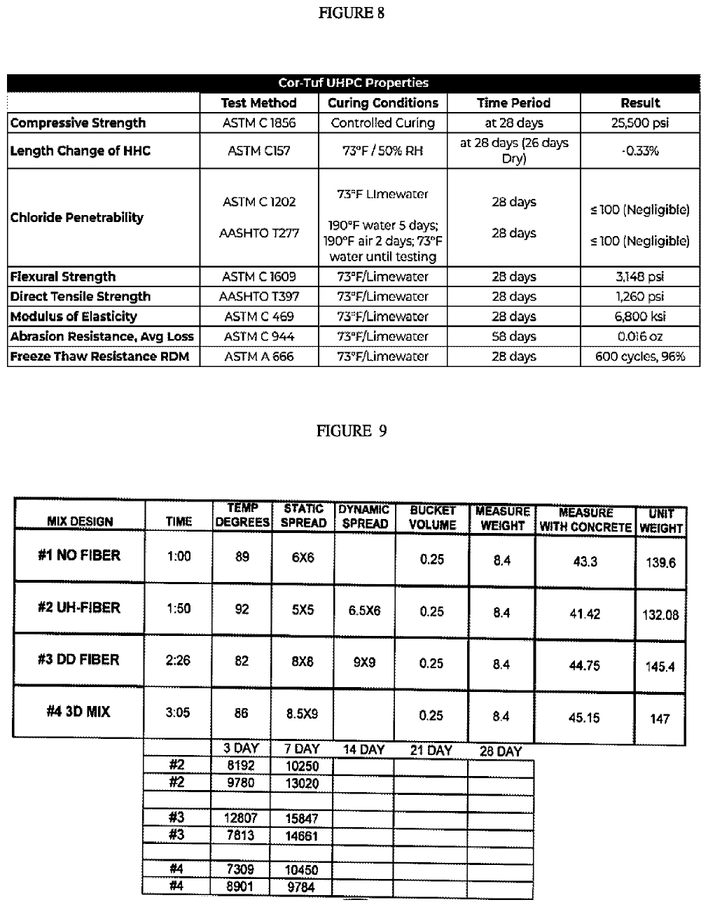

Referring now to FIG. 8 is a table showing CorTuf CT25 UHPC properties. This table shows ASTM and other standardized testing protocols for compressive strength, length change, chloride penetrability, flexural strength, direct tensile strength, modulus of elasticity, abrasion resistance (avg loss), and freeze thaw resistance.

FIG. 9 is a table showing psi strength after 3-day and 7-day curing periods for a mix designs compared to no fiber mixes, “UH-FIBER”, “DD FIBER”, and “3D mix”. FIG. 9 shows time and temperature variables for static spread, dynamic spread, bucket volume, measure weight, measure with concrete, and unit weight. FIG. 9 also shows Day 3 and Day 7 psi strength results for curing of two samples each of designs 2, 3, and 4.

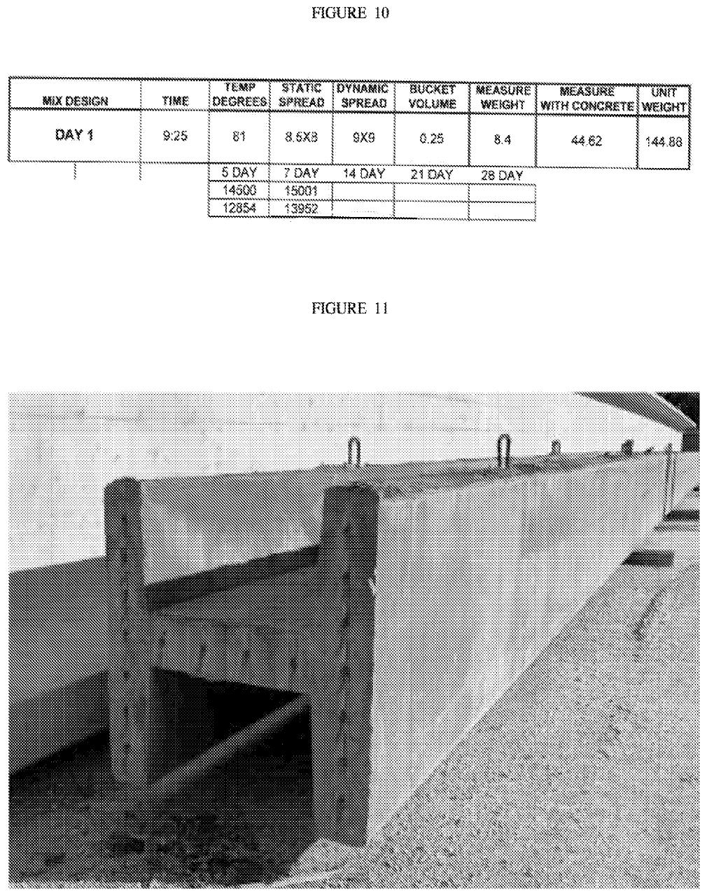

FIG. 10 is a table showing psi strength after 5-day and 7-day curing periods for a mix design “Day 1”. FIG. 10 shows time and temperature variables for static spread, dynamic spread, bucket volume, measure weight, measure with concrete, and unit weight. FIG. 10 also shows Day 5 and Day 7 psi strength results for curing of two samples each of design “Day 1”.

FIG. 11 is an image of an H pile constructed using the CT-25 UHPC herein. FIG. 11 shows that pre-cast forms can be used for many types of construction projects.

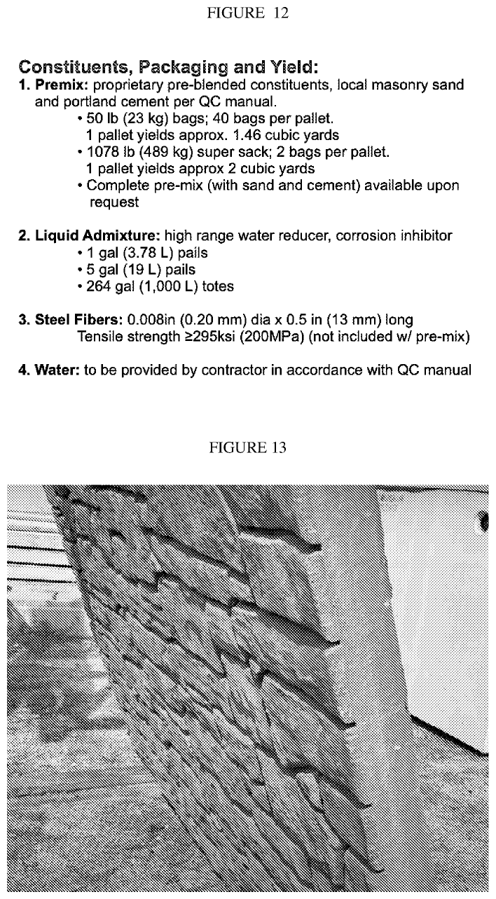

FIG. 12 is a table of CT25 UHPC constituents, packaging, and yield. FIG. 12 is a non-limiting example of an ingredient list for use in preparing the CT25 UHPC herein.

FIG. 13 is an image of a precast form (wall) made from a unitary pour of CT-25 UHPC. FIG. 13 shows that pre-cast forms can be used for many types of construction projects, including walls having decorative features.

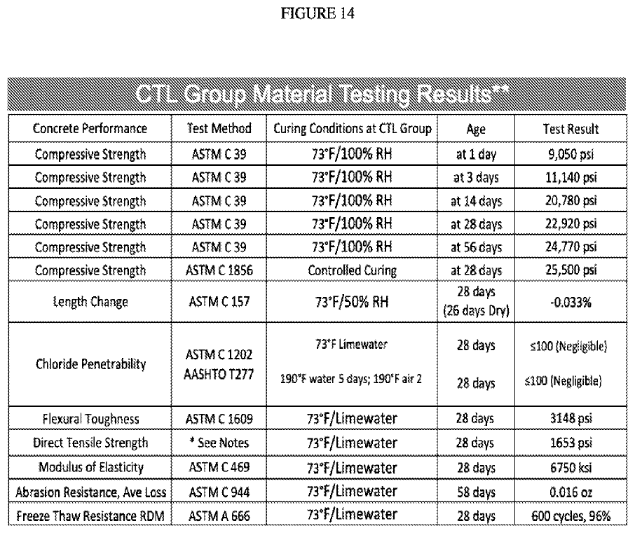

FIG. 14 is a table of CT-25 UHPC testing results. FIG. 14 shows the psi compressive strength for CT25 UHPC cured at a specific temperature and relative humidity over a range of days from 1, 3, 14, 28, 56. FIG. 14 shows the psi compressive strength for CT25 UHPC subject to controlled curing at a specific temperature and 50% relative humidity over 28 days. FIG. 14 shows the results for this test, including length change, chloride penetrability, flexural strength, direct tensile strength, modulus of elasticity, abrasion resistance (avg loss), and freeze thaw resistance.

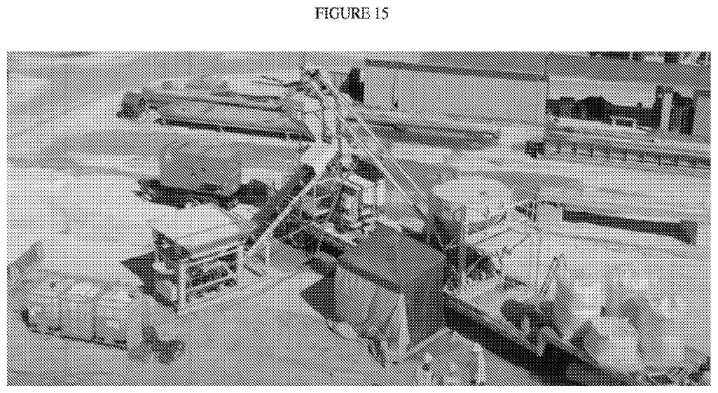

FIG. 15 is an image of a mobile batch plant. FIG. 15 shows a mobile trailer having hopper bins connected by feeders/augers for sand, cement, UHPC additive, and microfibers, as well as containers for dispensing admix and water. Super sacks containing specific components are loaded into the appropriate hopper and transported to a central mixing container. All of the required components of the mobile batch plant can be transported to a specific location reducing the need to mix offsite and transport CT25 UHPC to the pour location.

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations.

The embodiments described herein can include various combinations and/or sub-combinations of the functions, components, and/or features of the different embodiments described. Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

It is therefore to be understood that within the scope of the appended claims, the invention may be practiced otherwise than as described. Accordingly, all such modifications are intended to be included within the scope of this invention as defined in the following claims.

1. A batch process for making ultra-high performance microfiber concrete, comprising:
(i). Mixing fine aggregate 28-32 weight %, steel microfibers 5.0-7.0 weight %, and cement 28-32 weight %, for 60-120 seconds, to obtain a first homogenous dry mix, said fine aggregate comprised of sand, said steel microfibers are 13-38 mm in length and 0.20-0.63 mm in diameter, and said cement having a Blaine fineness of about 3000-4500 cm2/g;
(ii). Mixing a second dry mix into the first homogenous dry mix for 60-120 seconds, the second dry mix comprised of (i) silica fume 12-14 weight %, (ii) silica flour 7.0-9.0 weight %, and optionally (iii) cenospheres 5.0-7.0 weight %, to obtain a second homogenous dry mix;
(iii). Mixing water 6.0-7.0 weight % into the second homogenous dry mix to obtain a hydrated cement-containing paste having uniformly distributed steel microfibers; and
(iv). Mixing a high-range water-reducing admixture (HRWRA) 2.5-2.7 weight % into the hydrated cement-containing paste having uniformly distributed steel microfibers to obtain an ultra-high performance microfiber concrete (UHPMC);
wherein a total of all weight % equals 100%.

2. The process of claim 1, wherein carbon nanotubes 1.0-5.0 weight % are added to the first homogenous dry mix.

3. The process of claim 1, wherein said high-range water-reducing admixture is a combination of two or more admixtures selected from a superplasticizer liquid admixture, a water-reducing liquid admixture, and mixtures thereof, and wherein the high-range water-reducing admixture combination has a density of 1.04-1.06 g/cc.

4. (canceled)

5. (canceled)

6. The process of claim 1, wherein the process is performed in a redi-mix truck at a volume of about 8-11 cu. yds. (about 6-8 m3).

7. The process of claim 1, wherein the process is performed in a stationary mixer at a volume of about 1-3 cu. yds. (about 0.765-2.3 m3).

8. (canceled)

9. (canceled)

10. The process of claim 1, comprising (v). pouring or forming the ultra-high performance microfiber concrete (UHPMC) into a component selected from the group consisting of: a plate, a channel, a pipe, a tube, an I-beam section, an H-beam component, a WF-section, a smooth column, a fluted column, a connector, a panel, an endcap, an overlay, a wall panel, a roofing tile, a floor tile, an underflooring, a wall tile, a stepping stone, a planter, a truss, a joist, a rafter, a support gusset, a decking component, a footer, a mounting pad, a precast water conduit, a precast sewage pipe, a precast pipe connector, a brick, a refractory brick, a fireplace liner, a veneer, an oil and gas well cementing for casing, a seawall, a sea barrier block or form, an undersea piling, an undersea mounting pad, a harbor dock, a precast highway slab, a precast railroad tie, a precast parking block, a precast jersey barrier, a street curb, a sidewalk, a driveway apron, a countertop, a laboratory bench top, a warehouse flooring slab, a power station tower, a power station dam, and combinations thereof.

11. The process of claim 1, comprising (v). the step of pouring or forming the ultra-high performance microfiber concrete (UHPMC) into a component selected from the group consisting of: a vehicle up-armoring component, a ballistic armor component, a blast-resistant panel, a man-portable panel, a thin armor panel, a forced entry resistant structural element, an armored roofing tile, a ballistic wall panel, a ballistic floor tile, a hurricane and tornado resistant structural element, and combinations thereof.

12. The process of claim 1, comprising: mixing microinclusions into a dry mixture of first constituents to yield a first homogeneous mix, the microinclusions selected from the group consisting of silicon carbide, ultra-high molecular weight polyethylene fibers, carbon nanotubes, and multi-walled carbon nanotubes.

13. (canceled)

14. (canceled)

15. (canceled)

16. (canceled)

17. (canceled)

18. The process of claim 1, wherein said cement is portland cement with a calcium to silica ratio of less than about 3.1, wherein said silica fume is at least 96% silica with a maximum carbon content of less than about 4%, wherein said silica flour is crushed silica of less than about 40 microns in its longest dimension, and wherein said steel microfibers fibers have lengths between about 13 to about 38 mm and diameters between about 0.20 to about 0.63 mm.

19. (canceled)

20. The process of claim 1, comprising (v) forming said resultant cement-containing paste in the shape of a component, and (vi). curing said component by heating and hydrating said component.

21. The process of claim 20, wherein (vi) curing said component comprises, placing in an environment of approximately 100% relative humidity for about seven days at ambient temperature, submersing in water of approximately 85° C. to about 91° C. for about three to about five days, and heating in air at approximately 85° C. to about 91° C. for about one to about two days, wherein, said cured composition component becomes crystalline and has a compressive strength of 21,000-100,000 psi.

22. (canceled)

23. (canceled)

24. The process of claim 20, wherein heating step of curing comprises voltage heating by applying a voltage of about 40V to the steel microfibers of said component, the voltage applied using wire connectors that are directly connected to the steel microfibers.

25. (canceled)

26. (canceled)
